(19) United States
(12) Patent Application Publication
(10) Pub. No.: US 2012/0317290 A1
(43) Pub. Date: Dec. 13, 2012

(54) COMMAND AND CONTROL SYSTEM INTEGRATED WITH NETWORK MANAGEMENT

(75) Inventor: Stuart TAYLOR, West Sussex (GB)

(73) Assignee: ASTRIUM LTD., Hampshire (GB)

(21) Appl. No.: 13/491,015

(22) Filed: Jun. 7, 2012

(30) Foreign Application Priority Data
Jun. 8, 2011 (EP) 11004643.0-1243

(51) Int. Cl. G06F 15/173

(52) U.S. Cl. 709/226

(57) ABSTRACT

Asset control system that includes a network management system and a command and control system being structured and arranged to control assignments to assets and being integrated with the network management system to manage resource assignments to the assets controlled by the command and control system within a network.

### CROSS-REFERENCE TO RELATED APPLICATIONS

The present application claims priority under 35 U.S.C. §119(a) of European Patent Application No. 11 004 643.0-1243 filed Jun. 8, 2011, the disclosure of which is expressly incorporated by reference herein in its entirety.

### BACKGROUND OF THE INVENTION

1. Field of the Invention

The invention relates to a command and control system integrated with a network management system.

2. Discussion of Background Information

A Command and Control (C2) system in military refers to a technical system for usage by a commander for planning, directing, and controlling operations of assigned and attached forces. A C2 system uses assets such as unmanned aerial vehicles (UAVs) and ground-based reconnaissance systems, which transmit data via communication connections over the network to a C2 center, in which a commander can control operations of assigned forces and the assets.

C4ISTAR is a derivative of C2, which particularly refers to the infrastructure used to implement a computer and network technology based C2 system. C4ISTAR is composed of the acronyms C4I and STAR. C4I is an acronym for Command, Control, Computers, Communications, (military) Intelligence and refers to the ability of military commanders to direct forces by using networked computer systems. STAR designates the observations of enemies and operation areas and is an acronym for Surveillance, Target Acquisition, and Reconnaissance.

C2 and particularly C4ISTAR systems can use different media for communication, particularly for transporting data. For example, satellite communication can be used to transport data from or to an asset such as a vehicle to or from a C2 center.

An exemplary application of data transmission in a C2 system is the transmission of live video streams from cameras of UAVs to a C2 center via satellite communication (SatCom). Since SatCom resources are limited, particularly the bandwidths available for live video stream transmission, the resources are usually shared by the live video stream sources. For example, 12 UAVs can equally share an available SatCom bandwidth of 12 Mbps to a communication satellite so that each UAV has access to an assigned bandwidth of 1 Mbps.

### SUMMARY OF INVENTION

Embodiments of the invention are directed to improving a C2 system such as a C4ISTAR system, to improve the transport of data within the system.

According to embodiments of the present invention, a network management system is integrated with a C2 system, such as a C4ISTAR system, so that dynamic reassignment of network resources based on real-time requirements from the C2 system can be provided, thus, allowing a better accommodation of data transmission in the C2 system to real-time needs of customers, for example to dynamically alter bandwidth assignment of SatCom or other network resources based on the real-time needs of commanders.

An embodiment of the invention relates to a command and control system integrated with a network management system being adapted to manage resource assignments to assets controlled by the command and control system within a network.

The network management system may be integrated with the command and control system at an application layer and may handle a resource request for assigning resources within the network to assets received with a priority command from a command and control system.

The network management system may be adapted to dynamically respond to a priority command and to enable a service related to the priority command, particularly to enable a bandwidth reallocation within the network for assets.

The network management system may be further adapted to validate a resource request received with a priority command against constraints of the network.

The network management system may be also adapted to send a result message to the command and control management system signaling success or failure of a resource request received with a priority command.

In the system, an interface between the network management system and the command and control management system may be implemented as a direct interface or via a manager of managers system, which provides a common interface with individual management systems and a single hub for authorization and routing of requests from the individual management systems.

The manager of managers system may be adapted to maintain a dynamic directory of managed assets and to perform a lookup in the directory upon receipt of a resource request contained in a priority command received from a command and control system.

The manager of managers system may be further adapted to route a resource request contained in a priority command received from a command and control system according to additional supplied data within the priority command.

The network management system may be implemented as a service provider for a command and control system.

The network management system may particularly be based on a Service Oriented Architecture, particularly implemented using SOAP and HTTP.

Furthermore, the network management system may comprise a Web Services interface.

The command and control system may comprise one or more C4ISTAR systems.

The assets may comprise unmanned aerial vehicles, land vehicles, and/or video phones, and deliver data streams, particularly video and/or audio streams over the network to the command and control system.

Embodiments of the invention are directed to an asset control system that includes a network management system and a command and control system being structured and arranged to control assignments to assets and being integrated with the network management system to manage resource assignments to the assets controlled by the command and control system within a network.

According to embodiments, the integration of the network management system with the command and control system can be at an application layer and can handle a resource request for assigning resources within the network to assets received with a priority command from a command and control system. The network management system can be structured and arranged to dynamically respond to a priority command and to enable a service related to the priority command. The service related to the priority command may be a bandwidth reallocation within the network for assets. The network management system may be structured and arranged to validate a resource request received with a priority command against constraints of the network. The network management system can be structured and arranged to send a result message to the command and control system signaling success or failure of a resource request received with a priority command. An interface between the network management system and the command and control system may be implementable one of as a direct interface or via a manager of managers system, which provides a common interface with individual management systems and a single hub for authorizing and routing requests from the individual management systems. Further, the manager of managers system may be structured and arranged to maintain a dynamic directory of managed assets and to perform a lookup in a directory upon receipt of a resource request contained in a priority command received from a command and control system. The manager of managers system can be adapted to route a resource request contained in a priority command received from a command and control system according to additional supplied data within the priority command.

In accordance with embodiments of the invention, the network management system can be implementable as a service provider for a command and control system. The network management system may be based on a Service Oriented Architecture. Moreover, the Service Oriented Architecture can be implementable using at least one of SOAP and HTTP. The network management system can include a Web Services interface.

According to other embodiments of the instant invention, the command and control system can include one or more C4ISTAR systems.

Moreover, the assets can include at least one of unmanned aerial vehicles, land vehicles, and video phones. Further, the assets can deliver data streams over the network to the command and control system, and the data streams may include at least one of video and audio streams.

Embodiments of the instant invention are directed to a method for controlling assets. The method includes integrating a command and control system with a network management system, whereby resource assignments to the assets controlled by the command and control system are managed within a network.

According to embodiments, the network management system may be integrated with the command and control system at an application layer and method can further include handling a resource request for assigning resources within the network to assets received with a priority command from a command and control system.

In accordance with still yet other embodiments of the present invention, the assets may include at least one of unmanned aerial vehicles, land vehicles, and video phones.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a diagram illustrating the concept of an embodiment of a command and control system according to the invention;

FIG. 2 shows an exemplary application of the command and control system according to the invention for requesting a high bit rate video stream from a UAV;

FIG. 3 shows two embodiments of interfaces between a command and control system and a network management system according to the invention;

FIG. 4 shows an embodiment of a manager of managers system as interface between several command and control systems and network management systems according to the invention;

FIG. 5 shows a synchronous Web Services interface as embodiment of an interface between a command and control system and a network management system according to the invention;

FIG. 6 shows an asynchronous Web Services interface as embodiment of an interface between a command and control system and a network management system according to the invention; and

FIG. 7 shows manager of managers system as embodiment of an interface between two command and control systems and two network management systems according to the invention.

### DETAILED DESCRIPTION OF THE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

In the following, embodiments of the invention are explained by the concept for an integrated C4ISTAR and network management solution that provides dynamic reassignment of network resources based on real-time requirements from a C4ISTAR system. It should be noted that the invention is not constrained to only C4ISTAR, although only C4ISTAR will be used as an example of such. The embodiments of the invention extend the capabilities of a C4ISTAR system by including communications control allowing a customer to dynamically alter the bandwidth assignment of SatCom (or other network) resources based on the real-time needs of the commanders.

The concept underlying the embodiments of invention can be divided into two:
Primarily, integration of a C4ISTAR management system and a network management system (NMS) at the application layer to allow the C4ISTAR to prioritize how they want the bandwidth allocated to assets within an autonomous network.
Secondarily, the ability of the NMS to dynamically respond to a priority request and enable the service. Service means particularly a dynamical alteration of the bandwidth assignment in a network in response to service requests.

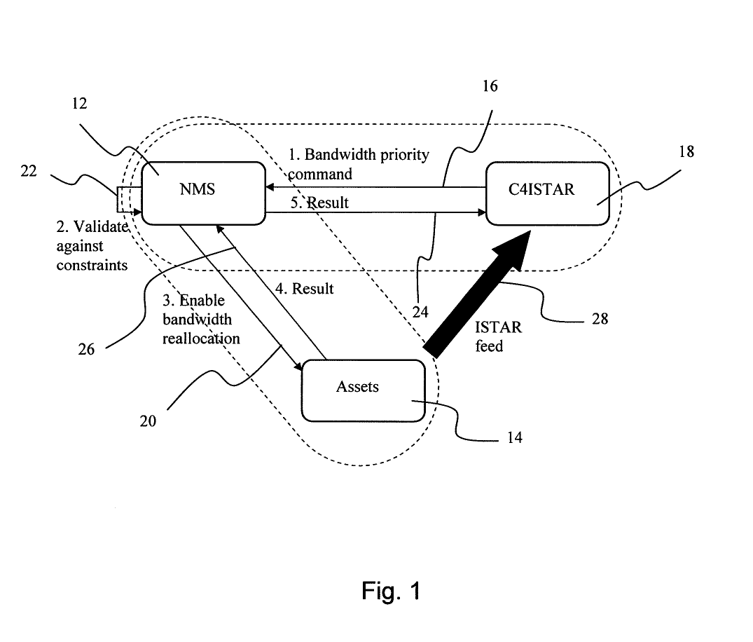

The diagram of FIG. 1 illustrates these two concepts, together with the chronological process for requesting and enabling the service. FIG. 1 shows a C2 system integrated with a NMS. A C4ISTAR system 18 of the system controls assets 14 such as UAVs, which transmit ISTAR feeds 28 to the C4ISTAR system 18 of a SATCOM network. The C4ISTAR system 18 can transmit a resource request 16 for assigning more bandwidth to a certain asset (in step 1, a bandwidth priority request is transmitted from the C4ISTAR system 18 to the NMS 12). The NMS 12 validates the requested bandwidth against constraints in step 2 (reference numeral 22 in FIG. 1). If step 2 fails steps 3 and 4 will be missed and a failure result with result message 24 will be sent to the C4ISTAR system 18. If step 2 succeeds, a command for enabling a bandwidth reallocation 20 is transmitted from the NMS 12 to the assets 14 in step 3. The assets 14 respond with a result message 26 to the NMS 12 informing whether the bandwidth reallocation was successful or failed in step 4. The result from step 4 will be returned with a message in step 5 i.e. success or failure, optionally with additional information such as a configured data rate, from the NMS 12 to the C4ISTAR system 18. If the bandwidth reallocation as requested by the C4ISTAR system 18 succeeded, the assets 14 will change the data rate according to the request, which influences the ISTAR feeds 28 from the assets 14 to the C4ISTAR system 18

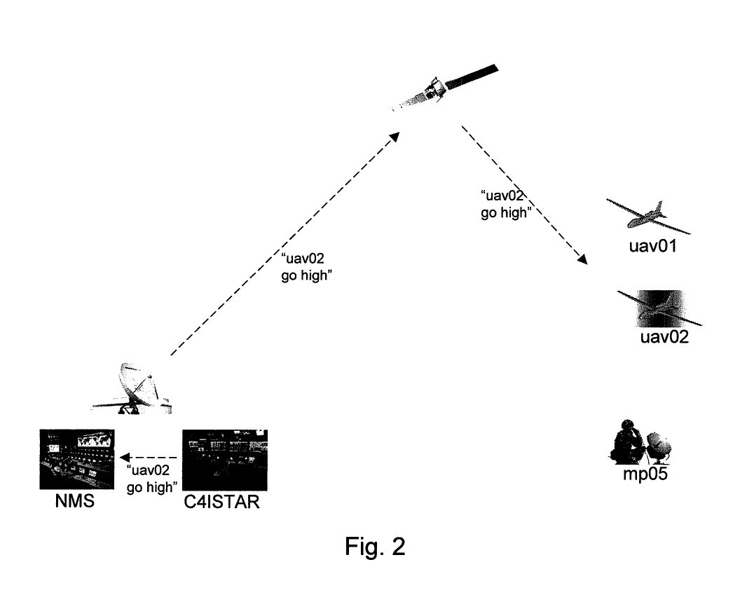

The scenario as shown in FIG. 2 and described in the following illustrates the process performed by the system shown in FIG. 1 and outlined above:

Satcom resources have been planned up and configured for an entire network of deployed assets including a group of for example 12 assets in a single deployment performing ISR (Intelligence, Surveillance, and Reconnaissance) sharing between them 12 Mbps bandwidth. Each asset is streaming a live video feed back to a command station of a C4ISTAR system. The assets as shown in FIG. 2 may be for example UAVs uav01, uav02 and satellite video phones mp05. Normally, the assets equally share the available bandwidth for video streaming.

The C4ISTAR system may provide a map based interface with real-time feeds of the 12 asset positions including the ability to view each video feed by selecting an asset from the map. Because the assets are sharing a limited bandwidth they can only stream low to medium quality video (normal definition) using roughly 1 Mbps.

A commander using the C4ISTAR system wishes to see more detail from a feed from one of the assets receiving higher quality video from that asset as quickly as possible.

This would require a change in the SatCom configuration to allow that asset to stream high definition video and use, e.g., 6 Mbps of the bandwidth whilst the remaining 11 assets would need to share the remaining 6 Mbps so each dropping down from 1 Mbps to roughly 512 Kbps. Because of the real-time nature of the scenario the changes on the SatCom configuration would need to be done dynamically and immediately.

The instruction is given from the C4ISTAR system to increase the required bandwidth for the asset to allow higher quality video. This could be enabled through a “single-click” function within the C4ISTAR software using GUI (Graphical User Interface) controls, for example by clicking on a “HD streaming video” button on the position of uav02.

This triggers an electronic message to the NMS, for example “uav02 go high” to apply the necessary reconfiguration (step 1 in FIG. 1). The message would consist of (as a minimum) the unique ID of the asset and the specific instruction e.g.,

<assetID>uav02</assetID><dataRate>max</dataRate>

The NMS processes the request (step 2 in FIG. 1) and reconfigures the elements of the network deployment over the air immediately (step 3 in FIG. 1) and the video feed can increase to high definition from the asset.

The command station can now receive high definition (HD) streaming video from that asset and if there is no spare capacity receives a lower quality video from the other assets in the deployment group.

The GUI reflects the switch to HD and current data rate is updated accordingly. If the request was unsuccessful an appropriate message would be returned from the NMS and the GUI would indicate this to the operator (steps 4 and 5 in FIG. 1).

When the higher rate feed is no longer required the configuration could be returned to it's original planned state by commanding normal video in the same manner.

Primarily, any modification to the configuration of the network should be constrained to an element of an autonomous network such as described in the above scenario. It should not require any modification to the satellite payload, nor impact on the rest of the network outside each deployment group. Any reconfiguration should be limited to those assets in the autonomous network.

Alternatively, if the bandwidth requirements are greater than the maximum that is available to the deployment and re-planning of the wider network exercise is allowed then the request could trigger a re-planning exercise of the network.

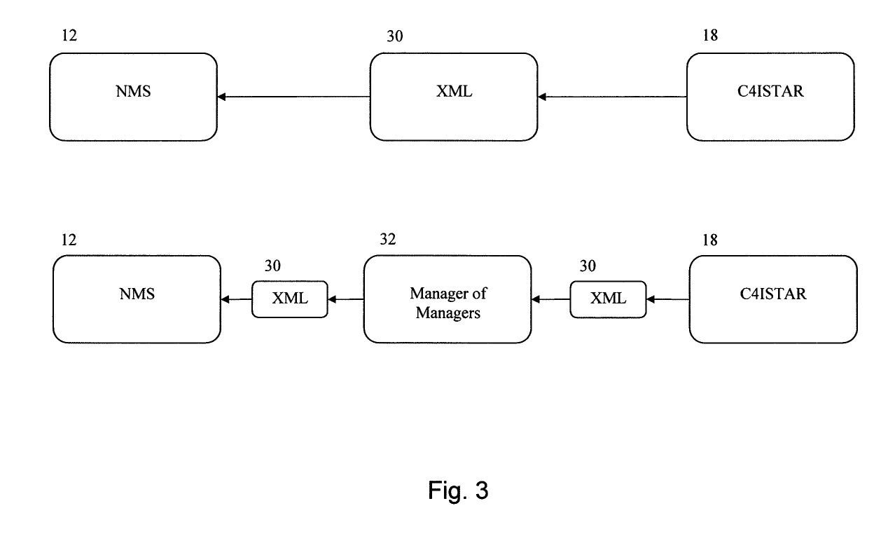

The interface between C4ISTAR 18 and NMS systems 12 can be realized both directly or via a Manager of Managers as shown in FIG. 3 depending on requirements. The direct electronic interface 30 would be completely automated. The interface via a Manager of Managers system 32 could have various degrees of automation depending on how much the interfaces are electronic, require operator interaction, or involve manual processes, and this would affect the responsiveness. If the C4ISTAR system 18 needs only to interface with one NMS 12 then a direct interface 30 would be sufficient. If the C4ISTAR system 18 uses resources managed by multiple NMSs 12 an interface to a Manager of Managers system 32 would mean that the C4ISTAR system 18 would not need to know which NMS 12 it needs to talk to since the Manager of Managers system 32 would manage that.

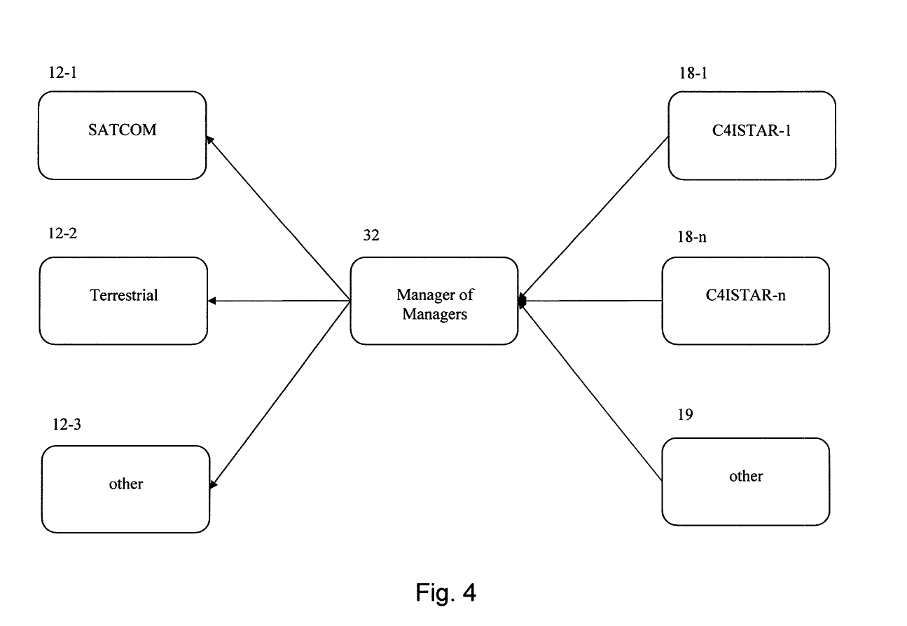

Using a Manager of Manager approach any combination as shown in FIG. 4 could be implemented: the Manager of Managers system 32 could control the access from several C2 systems such as several C4ISTAR-1 to C4ISTAR-n systems 18-1 to 18-n or other C2 systems 19 to different networks such as a SatCom network 12-1, a terrestrial network 12-2 or other networks 12-3.

A Manager of Managers system could provide a common interface with individual management systems, and a single hub for authorisation and routing of requests.

There are a number of technical mechanisms to allow applications to talk to each other, particularly based around open standards. As this is effectively a service offered by an NMS, to a C4ISTAR system, (and potentially other systems), an appropriate architecture to use would be a Service Oriented Architecture (SOA) implemented using SOAP over HTTP (Web Services).

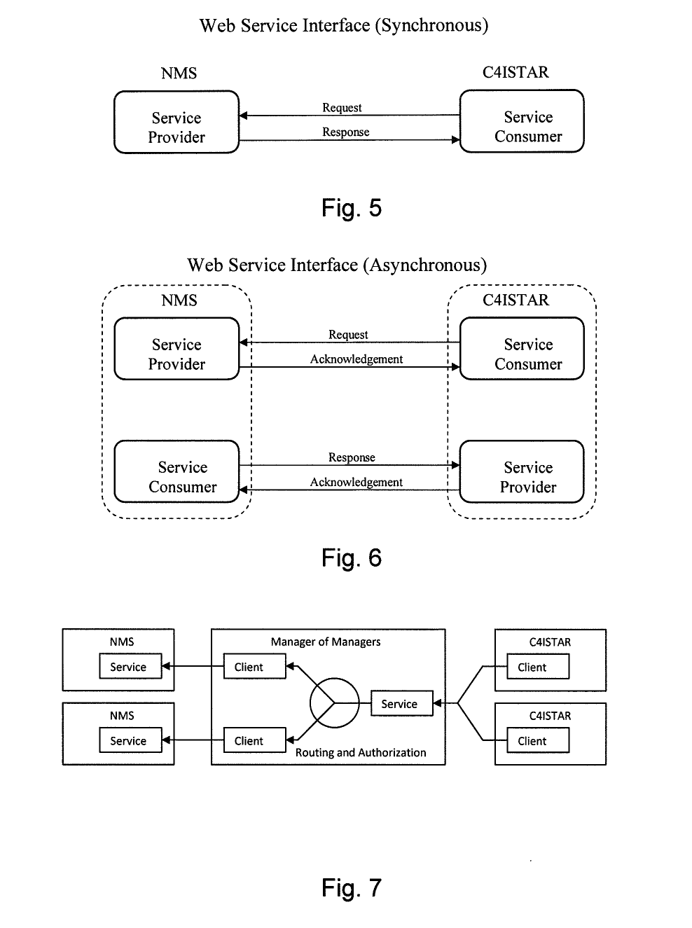

In this architecture an NMS would be an instance of a service provider and a C4ISTAR system would be an instance of a service consumer, as shown in FIG. 5. An example request could be “For this asset give me higher bandwidth” and the response could be “Request successful—asset given 6 Mbps”. The interface definition for the request and response can be typically defined in an XML schema that is provided by the Service Provider and adhered to by the Service Consumer.

Depending on the amount of time required for the Service Provider to respond to the request the interaction between the two entities may need to be a pair of asynchronous requests/responses as shown in FIG. 6. In this case the consumer of the first request receives an acknowledgement that the request has been received, validated, and is being processed rather than the result. The C4ISTAR system would need to provide a service for the NMS to send a response to asynchronously when it has completed processing the request. The NMS sends a response and it then receives an acknowledgement that the C4ISTAR system has received and validated the response.

The Service Oriented Architecture approach would work particularly well where there are multiple dispersed C4ISTAR systems that require the same service and/or where a C4ISTAR system requires services from multiple NMS. In the Manager of Managers solution this would use the architecture, as shown in FIG. 7.

If some assets are always managed by a particular NMS the Manager of Managers could route the service requests by maintaining a dynamic directory of managed assets and performing a lookup in that directory. If some assets are managed by multiple NMS e.g. UAVs transiting between LOS (Line Of Sight) and BLOS (Beyond Line Of Sight) then the Manager of Managers could route according to additional supplied data within the control message e.g.,

<assetID>uav02</assetID><dataRate>max</dataRate><source>BLOS</source>
or from another source. Finally, dynamic resource allocation in a NMS according to the invention is briefly discussed:

Within the NMS the dynamic resource allocation can be achieved in a number of ways, including the use of a DAMA (Demand Assigned Multiple Access) controller or ACM (Adaptive Coding and Modulation) using VBR (Variable Bit Rate) and CBR (Constant Bit Rate) to control the terminal bandwidth usage. These would give priority use of the bandwidth to the priority terminal(s) and the remaining terminals in the group would share the remaining bandwidth between them.

There are two scenarios to consider: where there has been planned over-allocation of resources to provide spare capacity, and where the full capacity has been allocated and the terminals are sharing the full bandwidth available. In the first instance increasing the bandwidth for an individual terminal could easily not impact the other terminals. In the second instance the data rates for the other terminals would need to be dropped.

The core concept of the present invention is the integration of C4ISTAR and Network Management Systems to extend the control capabilities of C4ISTAR into dynamic communications control through electronic interfaces. Further aspects of the invention are the concept and precise mechanism for dynamic bandwidth reallocation (Satcom or generic), the concept using SOA as application layer design, the concept utilizing the Manager of Managers approach in system architecture, the concept delivered through a “single-click” operator interaction.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission and wireless networking represent examples of the state of the art. Such standards are periodically superseded by faster or more efficient equivalents having essentially the same functions. Accordingly, replacement standards and protocols having the same functions are considered equivalents.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### REFERENCE NUMERALS AND ABBREVIATIONS

12 NMS
12-1 SATCOM NMS
12-2 terrestrial NMS
12-3 other NMS
14 assets
16 bandwidth priority command
18 C4ISTAR system
18-1 C4ISTAR system
18-n C4ISTAR system
19 other C2 management system
20 enabling bandwidth reallocation command
22 validation of bandwidth reallocation against constraints
24 result message from NMS to C4ISTAR system
26 result message from assets to NMS
28 ISTAR feed from an asset to C4ISTAR system
30 direct XML interface
32 manager of managers system
ACM Adaptive Coding and Modulation
C2 Command and Control
C4ISTAR Command, Control, Computers, Communications, (military) Intelligence, Surveillance, Target Acquisition, and Reconnaissance
CBR Constant Bit Rate
DAMA Demand Assigned Multiple Access
GUI Graphical User Interface
HD High Definition
HTTP Hyptertext Transfer Protocol
ID Identification
NMS Network Management System
SATCOM Satellite Communications
SOA Service Oriented Architecture
SOAP Simple Object Access Protocol
UAV unmanned aerial vehicle
VBR Variable Bit Rate

What is claimed:

1. An asset control system, comprising:
a network management system; and
a command and control system being structured and arranged to control assignments to assets and being integrated with the network management system to manage resource assignments to the assets controlled by the command and control system within a network.

2. The system of claim 1, wherein the integration of the network management system with the command and control system is at an application layer and handles a resource request for assigning resources within the network to assets received with a priority command from a command and control system.

3. The system of claim 2, wherein the network management system is structured and arranged to dynamically respond to a priority command and to enable a service related to the priority command.

4. The system of claim 3, wherein the service related to the priority command is a bandwidth reallocation within the network for assets.

5. The system of claim 2, wherein the network management system is structured and arranged to validate a resource request received with a priority command against constraints of the network.

6. The system of claim 2, wherein the network management system is structured and arranged to send a result message to the command and control system signaling success or failure of a resource request received with a priority command.

7. The system of claim 2, wherein an interface between the network management system and the command and control system is implementable one of as a direct interface or via a manager of managers system, which provides a common interface with individual management systems and a single hub for authorizing and routing requests from the individual management systems.

8. The system of claim 7, wherein the manager of managers system is structured and arranged to maintain a dynamic directory of managed assets and to perform a lookup in a directory upon receipt of a resource request contained in a priority command received from a command and control system.

9. The system of claim 7, wherein the manager of managers system is adapted to route a resource request contained in a priority command received from a command and control system according to additional supplied data within the priority command.

10. The system of claim 1, wherein the network management system is implementable as a service provider for a command and control system.

11. The system of claim 10, wherein the network management system is based on a Service Oriented Architecture.

12. The system of claim 11, wherein the Service Oriented Architecture is implementable using at least one of SOAP and HTTP.

13. The system of claim 11, wherein the network management system comprises a Web Services interface.

14. The system of claim 1, wherein the command and control system comprises one or more C4ISTAR systems.

15. The system of claim 1, wherein the assets comprise at least one of unmanned aerial vehicles, land vehicles, and video phones.

16. The system of claim 15, wherein the assets deliver data streams over the network to the command and control system.

17. The system of claim 16, wherein the data streams comprise at least one of video and audio streams.

18. A method for controlling assets, comprising:
integrating a command and control system with a network management system, whereby resource assignments to the assets controlled by the command and control system are managed within a network.

19. The method of claim 18, wherein the network management system is integrated with the command and control system at an application layer and method further comprises handling a resource request for assigning resources within the network to assets received with a priority command from a command and control system.

20. The method of claim 18, wherein the assets comprise at least one of unmanned aerial vehicles, land vehicles, and video phones.
